(19) United States
(12) Patent Application Publication
(10) Pub. No.: US 2003/0053798 A1
(43) Pub. Date: Mar. 20, 2003

(54) Personal video recorder

(76) Inventors: Magenya Roshanski, Rehovot (IL); Naftali Ben-Paz, Rehovot (IL)

Correspondence Address: William B. Ritchie, 43 Jackson Street, Concord, NH, 03301, US

(21) Appl. No.: 10/102,520

(22) Filed: Mar. 20, 2002

Related U.S. Application Data
(60) Provisional application No. 60/277,901, filed on Mar. 22, 2001.

(51) Int. Cl. H04N 5/781

(52) U.S. Cl. 386/111; 386/125

(57) ABSTRACT

A stand-alone personal video recorder that can be integrated directly into a television set, as well as other Original Equipment Manufacturer (“OEM”) devices. The personal video recorder (“PVR”) of this invention utilizes MPEG-2 standard encoding and decoding devices coupled with a hard disk drive for storage. The PVR is compatible with the common video broadcast formats, namely NTSC (National Television Standards Committee), PAL (Phase Alternating Line system) or S-Video forms. The small size and the low power consumption of the PVR of this invention allows for an easy and efficient incorporation into various OEM devices, including television sets, IRD recorders, digital VCRs, as well as state-of-the-art home entertainment centers.

### FIELD OF THE INVENTION

The present invention relates to the field of devices used generally to store and retrieve video programming and, more particularly, to a stand-alone personal video recorder that can be integrated into a television set thereby allowing local control and enhanced video viewing.

### BACKGROUND OF THE INVENTION

With the widespread availability of cable television and the increase in channel capacity, television viewers today have a virtually endless number of programming choices. Not only is there a vast array of programs and movies from which to choose, but programming is offered twenty four hours per day on the majority of television channels.

Although the television viewers today benefit from the increased programming choices, there remain many drawbacks and inconveniences associated with real time viewing of television programs. For example, a viewer may desire to view a particular program only to be precluded from doing so because the program is aired at an inconvenient time for the viewer. Even when the viewer is able to watch a program as it is being broadcast, it may be difficult for the user to focus his or her attention on the program due to telephone calls and other typical interruptions.

With the widespread availability of video cassette recorders (VCRs), the ability to record television programs for viewing at a later time has become essentially universal. Not only can VCR users record television programs for subsequent viewing, but they have more control over their viewing of the prerecorded material. Once a program is recorded, a VCR user can view the program when he or she wishes. Moreover, the user can control the viewing experience by utilizing VCR operator controls such as REWIND, FAST FORWARD and PAUSE. If the viewer is interrupted, he can simply stop the program and come back at a later time to finish watching it.

However, the use of VCRs is limited in that the conventional VCR can only record one program stream at a time. If there are two programs being broadcast simultaneous on separate channels, the VCR user can only record one of the programs. With the ever-increasing number of channels available to today's television viewers, it frequently occurs that a viewer would like to record multiple programs being broadcast at the same time, especially as many channels concentrate their popular programming during prime time viewing hours.

Furthermore, if a viewer is using the VCR to view a prerecorded program, the viewer cannot simultaneously record another program being broadcast real time. If a viewer is watching a television program as it is being broadcast real time, and she is interrupted by a five-minute telephone call, she may choose to record the remainder of the program. But when the telephone call ends, she does not have the option of simply watching the program from the point at which the program was when the telephone call came. This is because if the program is still being broadcast in real time, the viewer would have to rewind the videotape to the point at which she was interrupted, but she could not then use the VCR to record the remainder of the program being broadcast in real time.

Thus, there exists the need for a device that allows for recording of multiple programs being broadcast simultaneously. There further exists the need for a device that allows the user to record one or more programs being broadcast live while at the same time allowing the viewer to watch a prerecorded program. The device should further allow the viewer to effectively suspend live broadcasting in order to deal with an interruption and then resume the broadcast from the point of interruption, even as the program continues to be broadcast live.

There are available on the market today services to which viewers can subscribe that allow for greater control of their viewing experiences. For instance, TIVO is a subscription service that offers its subscribers various programming and recording options that overcome many of the VCR's limitations. In order to take advantage of the TIVO service, subscribers must connect an external digital recorder to their television set. The recorder can be programmed through the service to digitally record particular television shows at particular times and can record multiple shows being broadcast at the same time. The use of the digital recorder in conjunction with the TIVO service allows for video time shifting by temporarily storing digital recorded matter so that live broadcasting can be temporarily “paused” for a short period of time.

Although services such as TIVO overcome many of the limitations of VCR viewing, there remains the need for a device that allows viewers to have complete local control over their television viewing without having to subscribe to expensive services. There further exists the need for a device that will allow users to control their viewing experience without having to purchase and use recording devices that operate external to and independently of their television set. There also is a need for a device that, through local storage of prerecorded commercial material, can forward targeted commercial advertising to particular viewers during particular television broadcasts.

### SUMMARY OF THE INVENTION

The present invention is directed toward a stand-alone personal video recorder that can be integrated directly into a television set, as well as other Original Equipment Manufacturer (“OEM”) devices. The personal video recorder (“PVR”) of this invention utilizes MPEG-2 standard encoding and decoding devices coupled with a hard disk drive for storage. The PVR is compatible with the common video broadcast formats, namely NTSC (National Television Standards Committee), and PAL (Phase Alternating Line system). The small size and the low power consumption of the PVR of this invention allows for an easy and efficient incorporation into various OEM devices, including television sets, IRD recorders, digital VCRs, as well as state-of-the-art home entertainment centers. Integrated Receiver/Decoder or in other words a PVR integrated in a Settop box.

Regardless of the OEM device in which the PVR is integrated, the PVR can be operated by a remote control thereby further enhancing the viewing experience.

In its elemental form, the PVR of the present invention comprises a printed circuit board and a hard disk drive for storage of any digitally recorded programming. The circuit board includes an analog decoder that receives analog video streams and converts the streams into digital CCIR 656 form. The circuit board also includes a digital encoder that accepts a real time digital video stream, compresses it and encodes into an MPEG-2 stream. Video streams encoded in the MPEG-2 standard can then be stored on the hard disk drive. The circuit board further includes a decoder that can take stored MPEG-2 streams and decode them back to analog and digital video format.

The PVR's compression and storage of audio and video signals allows for a highly interactive television and video viewing experience. When the PVR is integrated into an OEM device, such as a television, the user of the device will be able to digitally record television programs, without the need for videotape. Moreover, the user will be able to enjoy various simultaneous recording and playback options as well as various “trick play” modes. Without having to rely on a service provider, viewers can use the integrated PVR to have complete local control over their individual viewing experiences.

It is an aspect of this invention to provide a device that allows for television and video viewers to have complete local control of their individual viewing experiences.

Is another aspect of this invention to provide a stand-alone PVR that can be fully integrated into a television set or other OEMs, such as a digital VCR, an IRD (Integrated Receiver/Decoder), or a state-of-the art home entertainment center.

It is an aspect of the invention to allow users to record broadcast program while simultaneously watching another live or prerecorded program.

It is another aspect of this invention to allow users to “pause” a live broadcast during a viewing interruption and resume watching the broadcast from the point of interruption.

It is an aspect of the invention to allow a user, after having paused a live broadcast, to continue recording and then review the recorded programming in either normal speed or fast-forwarded speed to “catch up” to the live program.

It is a further aspect of the invention to allow viewers to enjoy various “trick play” modes such as INSTANT REPLAY, PAUSE, FAST FORWARD, REWIND, of prerecorded programming while at the same time recording one or more live broadcasts.

It is an aspect of the PVR to allow viewers to instantly access any portion of prerecorded video, rather than having to rewind or fast forward sequentially through recorded video.

It is another aspect of the PVR of this invention to provide high quality video recording and storage without the image degradation associated with conventional VCR recording and tapes.

It is an aspect of the invention to provide highly reliable storage of recorded video.

It is a further aspect to provide a PVR that allows local storage of particular commercial programming so it can be targeted to the specific PVR user.

It is an aspect of the invention to provide a PVR that can be controlled with the same remote control device that controls the television set or OEM in which the PVR is integrated.

### BRIEF DESCRIPTION OF THE DRAWINGS

FIG. 1 is a block diagram of the PVR and its interfacing with a conventional television set.

FIG. 2 is a block diagram illustrating the individual components of the printed circuit board of the PVR.

### DETAILED DESCRIPTION OF THE INVENTION

Fundamentally, the PVR of this invention receives an incoming video stream, compresses the stream into a digital format, stores it on a hard disk drive in its compressed form, and upon user demand, converts the stream back into a decompressed form for display to the viewer. Because the PVR operates within the television set or other OEM device, the user has complete control of the viewing experience without any requirement for subscription to a remotely operated service.

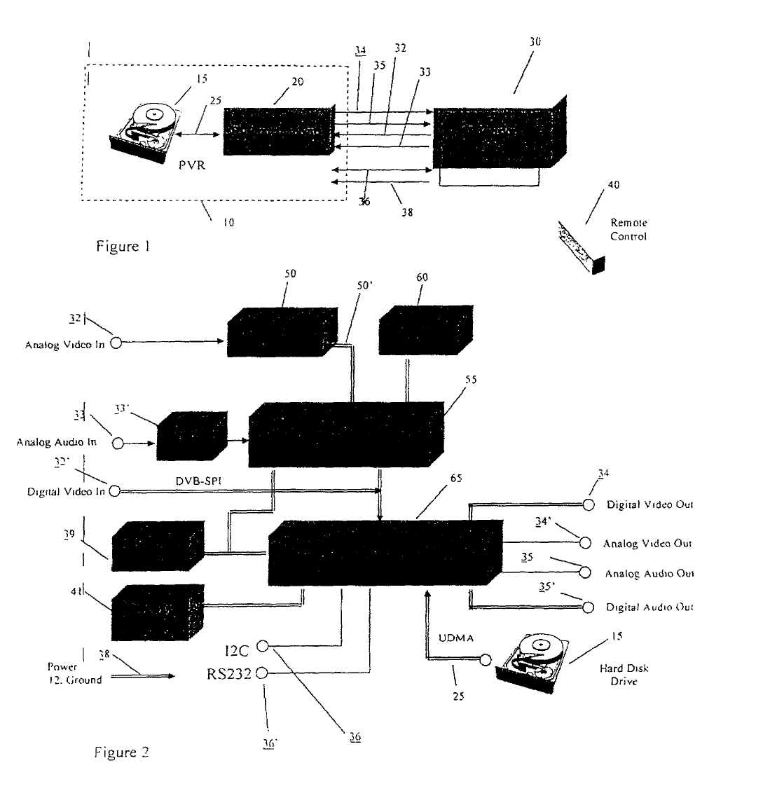

As illustrated in FIG. 1, the architecture of the PVR 10 of this invention fundamentally comprises a hard disk drive 15 and a printed circuit board (PCB) 20 which houses the individual video encoding, compression and decoding components of the PVR 10. In the preferred embodiment of the invention, the PCB 20 is coupled to a conventional hard disk drive 15 using a conventional hard disk drive interface 25. The preferred embodiment of the PVR 10 of this invention can accommodate either an Integrated Drive Electronics (IDE) interface or an Ultra DMA standard interface. The support of both these interfaces assures connectivity to most industry standard hard disk drives. There generally are six main interfaces between the PVR 10 and the OEM device in which the PVR 10 is integrated. For purposes of illustration, the OEM shown in FIG. 1 is a conventional television 30. A video input interface 32 and an audio input interface 33 are used to feed a live video program and a live audio stream respectively from-the television 30 to the PVR 10. A video output interface 34 and an audio output interface 35 are used to feed video and audio signals respectively to the television 30 for viewing by the user. The operations of the PVR 10 are controlled by signals sent and from the television or other OEM through a operations control interface 36. The preferred embodiment of the PVR 10 of this invention utilizes an 12C interface for the operations control interface 36. An 12C interface is an industry standard by bi-directional 2-wire interface. Additionally, the PVR 10 can utilize an RS232 standard interface to control the operations of the PVR 10. These interfaces are common means of controlling circuits within modern television sets and each is well known to those ordinarily skilled in the art. The operations of the PVR 10 can be controlled by the user through a remote control device 40.

The stand-alone PVR 10 of this invention can be powered through +5 or +12 volt power control interface 38 to the television 30 or other OEM device and a common ground. Due to the small size and low power consumption of the PVR 10, it can easily be integrated into a television set or other OEM devices. While no mechanical or electrical modifications are normally required to integrate PVR 10 into television 30 or other OEM devices; in some cases, a particular OEM manufacturer may want to customize the functions or control of PVR 10. This can be accomplished by modifying the on-board operating software residing in flash memory 39.

As explained further below, the hard disk drive 15 is used to store compressed video and audio data, device configuration data, and other non-volatile information such as electronic programming data. The video and audio data is stored on the hard disk drive 15 in MPEG-2 compression standard, while other data is stored as is. The amount of data that can be stored on the hard disk drive 15 is dependent on the disk size used and the compression ratio of the data. In “high video quality” mode (close to DVD quality) close to 2 gigabytes of storage is required for every hour of recorded video, while in “low quality mode” (close to VHS tape) close to 600 megabytes of storage is needed for every hour of recorded video. Accordingly, an eight-gigabyte hard disk drive can store four or more hours of good quality video. A larger disk drive can of course store more.

The PVR 10 of this invention utilizes MPEG-2 encoding/decoding architecture to enhance the traditional television viewing experience. MPEG-2, developed by the Moving Pictures Expert Group, is a standard for digital video and audio compression and decompression. By decompressing and encoding a video stream, the PVR can minimize necessary storage space and bandwidth requirements, thereby enhancing the overall system efficiency while reducing the overall system cost.

Referring now to FIG. 2, a description of the individual components of the PCB 20 is given. Because many available video signals are available in analog form only, the PVR 10 includes on the PCB 20 an analog decoder 50 that can decode standard analog signals and convert them into digital form. Analog digital signals typically are streamed in any one of the major international television standards such as NTSC (National Television Standards Committee), PAL (Phase Alternating Line system) Composite or S-Video forms. Devices used to decode analog signals and convert them into digital form are common in the industry and familiar to those skilled in the art. The preferred embodiment of this invention utilizes for the analog decoder 50 a PHILLIPS SAA7114 video decoder, which can decode an NTSC, PAL standards, in Composite or S-Video format signal into a digital video stream in the digital form 50′. The audio input is analog. Analog to Digital Converter 33′ is used to convert the analog audio input to a digital format. Analog to Digital Converter 33′ is a standard well known in the art device.

If the video program to be recorded is received in digital format 32′, such as the DVB-SPI standard that is a common output of digital tuners, it need not be converted by the analog decoder 50. Because a DVB-SPI signal is already encoded in MPEG-2 format, it bypasses the KFIR II Processor 55, and is fed directly into the Sti5512 decoder 65. This provides improves picture quality by eliminating the need to first go through an analog to digital conversion stage. These are described in the next paragraph.

The digital video stream, and the digitized audio stream, are fed to an MPEG-2 encoder 55. MPEG-2 encoding is a well known process by which a video and audio stream are compressed into a standardized format. The PVR 10 utilizes a local SDRAM storage device 60, external to the MPEG-2 encoder 55, to temporarily store intermediate video frames during the encoding process. The MPEG-2 compression allows for local storage of a significant amount of video and audio data on the hard disk drive 15 of the PVR 10.

MPEG-2 encoding devices are well known in the art, and a variety of processors can be used for the MPEG-2 encoding. The inventors have utilized a KFIR II Processor for the MPEG-2 encoder 55 of the preferred embodiment of this invention. Once a program stream has been decoded into MPEG-2 standard, the compressed digital stream is stored on the hard disk drive 15 for later viewing on demand.

To display previously stored video and audio streams that have been stored on the hard disk drive 15, the streams must first be decoded from the MPEG-2 compressed format. The PVR 10 utilizes a video processor 65 to decode the compressed stream either back to analog video format (NTSC or PAL) or into CCIR 656 digital format depending on whether the OEM user display is in analog or digital form. There are available various video processors capable of decoding MPEG-2 streams that can be used in the PVR 10. The preferred embodiment of the PVR 10 of this invention utilizes the ST MICROELECTRONICS STi5512 Omega video processor for MPEG-2 decoding.

Overall control of the preferred embodiment of the PVR is performed also by the video processor 65. The STi5512 Omega Video processor is capable of controlling the operations of the PVR 10, although other similar processors can be used. The STi5512, as well as other members of the STi55XX family, contains an embedded DSP (Digital Signal Processor). This DSP, rated at 60 MIPS, is capable of performing general purpose computing operations. The “PVR Control” program running on this DSP is responsible for initializing the PVR hardware after power-up or reset and loading the correct configuration into the Encoder and the Decoder section of the PVR. In addition, the “PVR Control” program accepts control commands from RS-232 and 12C ports and reconfiguring the PVR components according to the command. A flash memory 39 is connected with the video processor 65. The video processor 65 must be capable of controlling the power-up of the PVR 10, the system configuration initialization and setup. The video processor 65 also controls the hard disk drive 15, the MPEG-2 encoder 55, the MPEG-2 decoding function, as well as the graphics of the onscreen display for user control.

As illustrated in FIG. 2, the PVR 10 accepts a live broadcast video through the video input interface 32. If the live video stream is already in digital form, the stream is fed directly to the MPEG-2 encoder 55 for compression and encoding. If the live video stream is in analog form, it is first fed to the analog video decoder 50 where it is converted into digital CCIR 656 format before being fed to the MPEG-2 encoder 55 for compression and encoding. The digital audio stream associated with the live video stream is received through the audio input interface 33 and is fed to the MPEG-2 encoder. Once the input video and audio streams are compressed and encoded into MPEG-2 format, they are processed by the video processor Sti5512 65 and stored on the hard disk drive 15 for later retrieval upon command by the user. The clock, horizontal and vertical synchs derived in the Video Decoder 50 are directly driving video processor Sti5512 65. In this manner, this synchronization prevents video artifacts from being created inside television 30. The compressed data is packaged into fixed-length blocks and are written on the hard-disk drive 15 one block at the time. The size of the block is optimized for disk-drive performance. The sequence of the blocks on the hard disk drive is unique to assure content protection. In other words, a PC or other standard computer can't read the information stored by the PVR on the disk drive. It can only be read by another PVR. Upon a retrieval command by the user, a compressed video program, and its associated audio stream, can be retrieved from storage on the hard disk drive 15 for viewing. The compressed video and audio streams are fed to the video processor 65 for MPEG-2 decoding. After the MPEG-2 decoding process is complete, a video output stream is fed to the television 30 through the video output interface 34. The associated decompressed audio stream is likewise fed to the television 30 through the audio output interface 35.

The PVR user's ability to access and control the viewing of video and audio streams stored in MPEG-2 format allows for a highly enhanced and interactive viewing experience. A program stored on the PVR 10 can be accessed precisely and quickly because a user can direct the PVR 10 to retrieve a particular program without having to filter through other material stored on the hard disk drive 15. Conventional VCR recording is done sequentially, thereby often requiring the user to fast forward and rewind through recorded material to access a particular prerecorded program. With the PVR 10, accessing a particular program is more akin to choosing a particular song on a compact disk—the user simply selects the program to be viewed, and he or she has virtually immediate access to the program. Additionally, the hard disk drive 15 of the PVR 10 allows for local storage of the recorded and compressed video. In conjunction with-the ability to record a live broadcast while viewing prerecorded material, viewers can effectively “pause” a live broadcast while attending to interruptions that occur during the live broadcast of the program. For instance, a viewer who wishes to watch his favorite weekly sitcom can command the PVR 10 to record the live broadcast. The PVR 10 then records the program and stores the compressed video stream on the hard disk drive 10. If the telephone rings during the live broadcast and the viewer is interrupted for five minutes of the live broadcast, the live broadcast continues to be stored and recorded on the hard disk drive 15. When the viewer returns from his interruption, he can command the PVR 15 to display the recorded program from the point of the interruption while continuing to record the live broadcast. Because the PVR 10 is capable of displaying recorded material to the viewer while simultaneously recording the live broadcast, the viewer can simply continue watching the recorded program essentially with a five-minute delay from the live broadcast. After pausing a program, pressing a FAST FORWARD button will automatically fast forward the pre-recorded program until the PVR ‘catches up’ with real time broadcast. Then the display switches to show real time programming content.

As a further example, a user can rewind a program to a specified point of interest, for example to view again a touchdown in a football game.

The PVR's ability to compress and store prerecorded video streams allows for prerecorded advertising material, i.e., commercials, to be stored and incorporated into television programs based on the particular user of the PVR. In other words, commercials can be selectively stored on a particular viewer's PVR to cause those commercials to be targeted to particular consumers. Control of the recording process and playback can be accomplished via coded signals embedded in the VBI (Vertical Blank Interval). When the TV is not in use (for example at night time), upon commands issued in the VBI, several prerecorded commercials can be downloaded into the hard drive 15 from a special TV channel dedicated for this purpose. At a later time, when TV is in use, and during a commercial time slot, other commands issued in the VBI can direct a specific pre-recorded message to play.

Although a preferred embodiment of the invention has been described using specific terms, such description is for illustrative purposes only, and it is to be understood that changes and variations may be made without departing from the scope or spirit of the following claims.

What is claimed is:

1. A personal video recorder for a device having at least one video stream signal and corresponding audio signal, said personal video recorder comprising:
a printed circuit board that is connected directly to said device such that said printed circuit board receives both electrical power and said at least one video stream signal and corresponding audio signal from said device and wherein said printed circuit board encodes and compresses said at least one video stream and corresponding audio signal into an MPEG-2 second stream signal;
an industry standard hard disk drive connected to said printed circuit board such that said MPEG-2 second stream signal is stored onto said hard disk drive.

2. The personal video recorder of claim 1 wherein said printed circuit board further comprises decoding circuitry such that the stored MPEG-second stream signal is converted to a display video stream signal that corresponds to said at least one video stream signal and an audio output signal that corresponds to said corresponding audio signal such that the display video stream signal and audio output signal is presented to a viewer.

3. The personal video recorder of claim 2 wherein said printed circuit board further comprises an embedded digital signal processing control means for initializing said personal video recorder after power-up and for loading the correct configuration into the encoder and decoding circuitry of said personal video recorder and for initiation program control command signals in accordance with a selection by said viewer.

4. The personal video recorder of claim 3 wherein said control means accepts control commands from RS-232 and 12C ports and wherein said control means reconfigures said personal video recorder is response to the control command received via the RS-232 and 12C ports.

5. The personal video recorder of claim 3 wherein control means further comprises automatic detection means for automatically detecting the video format of said at least one video stream wherein said video format is a format selected from the group consisting of NTSC, PAL and S-Video and for automatically detecting the required video format of the display viewed by the viewer such that said display video stream signal is provided in a format selected from the group consisting of NTSC, PAL and S-Video and wherein the format of said at least one video stream and said display video stream signal are independent of one another.

6. The personal video recorder of claim 3 wherein said control means further comprises automatic recording means for recording said at least one video stream and corresponding audio signal wherein said device is in a stand-by mode.

7. The personal video recorder of claim 3 wherein said printed circuit board further comprises an on-screen display means for replacing an on-screen display that is provided by said device.

8. The personal video recorder of claim 3 wherein said decoding circuitry further comprises a video input decoder and an output decoder and synchronization means for synchronization of said video input decoder and output decoder.

9. A personal video recorder for a device having a housing and having at least one digital video stream signal in DVB-SPI format and corresponding audio signal, said personal video recorder comprising:
an industry standard hard disk drive;
a printed circuit board that is connected directly to said device and said hard drive such that said printed circuit board receives both electrical power and said at least one digital video stream signal and corresponding audio signal from said device and wherein said at least one digital video stream signal is fed directly to board decoding circuitry such that the decoded at least one digital video stream signal and corresponding digitized audio signal can be presented to a viewer or stored on said hard disk drive.
